(19) United States
(12) Patent Application Publication
(10) Pub. No.: US 2026/0319247 A1
(43) Pub. Date: Oct. 15, 2026

(54) REPROJECTION USING EYE TRACKING AND DEPTH ESTIMATION FOR AN EXTENDED REALITY DEVICE

(71) Applicant: Rivet Industries, Inc., Washington, DC (US)

(72) Inventors: Jouya JADIDIAN, Los Gatos, CA (US); Mohit NARANG, Cupertino, CA (US); Calin CRISTIAN, Iasi (RO)

(21) Appl. No.: 19/644,673

(22) Filed: Apr. 10, 2026

Related U.S. Application Data
(60) Provisional application No. 63/787,518, filed on Apr. 11, 2025.

(51) Int. Cl. G02B 27/00; G02B 27/01; G06F 3/01; G06T 7/50

(52) U.S. Cl. CPC G02B 27/0093; G02B 27/0172; G02B 27/0176; G06F 3/013; G06T 7/50; G02B 2027/0138; G02B 2027/014; G02B 2027/015; G02B 2027/0152; G06T 2207/20084

(57) ABSTRACT

In an embodiment, a method includes receiving scene data of a scene captured by a camera during a time period. The method further includes generating a rendering of the scene at a display based on the scene data. The method further includes estimating a first depth between an object at the scene and the camera, based on the scene data. The method further includes receiving eye-tracking data (1) for an eye of a user and (2) captured by an eye-tracking sensor during the time period. The method further includes estimating a gaze point of the eye during the time period and associated with the object at the scene, based on the eye-tracking data. The method further includes estimating a second depth between the eye of the user and the gaze point of the user, based on eye-tracking data and a focal depth of the eye of the user.

### CROSS-REFERENCE TO RELATED APPLICATION

This application claims priority to U.S. Provisional Patent Application No. 63/787,518, filed Apr. 11, 2025 and titled “REPROJECTION USING EYE TRACKING AND DEPTH ESTIMATION FOR AN EXTENDED REALITY DEVICE,” the contents of which are incorporated by reference herein in its entirety.

### FIELD

One or more embodiments relate to reprojection using eye tracking and depth estimation for an extended reality device.

### BACKGROUND

Known extended reality (XR) systems, especially those not equipped with time of flight sensors, often do not provide accurate rendering of video passthrough and virtual content at varying depths, such as in mixed reality environments where passthrough/virtual objects seamlessly integrating with the real world is desirable.

These known approaches typically rely on fixed focal planes, manual depth adjustments, or complex hardware solutions that increase device weight and cost. These known approaches often result in the accommodation-vergence conflict, where the user's eyes attempt to focus at one distance while converging at another, causing visual discomfort, eye strain, and reduced immersion.

Additionally, known systems lack the ability to dynamically adjust stereoscopic rendering based on real-time user attention, forcing users to adapt to the system rather than the system adapting to natural human visual behavior. This creates particular challenges for users who desire precise depth perception for professional applications such as surgery, engineering, or detailed design work, where inaccurate depth cues can lead to errors and reduced efficiency.

### SUMMARY

In an embodiment, an XR headset includes a set of eye-tracking sensors, a set of cameras, a display, a memory, and a processor operatively coupled to at least one of the set of eye-tracking sensors, the set of cameras, the display, or the memory. The processor is configured to receive scene data of a scene captured by the set of cameras during a time period. The processor is further configured to generate a rendering of the scene at the display based on the scene data. The processor is further configured to estimate a first depth between an object at the scene and the set of cameras, based on the scene data. The processor is further configured to receive eye-tracking data (1) for at least one eye of a user and (2) captured by the set of eye-tracking sensors during the time period. The processor is further configured to estimate a gaze point of the at least one eye during the time period and associated with the object at the scene, based on the eye-tracking data. The processor is further configured to estimate a second depth between the at least one eye of the user and the gaze point of the user, based on the eye-tracking data and a focal depth of the at least one eye of the user. The processor is further configured to update the rendering based on a comparison of the first depth and the second depth to generate an updated rendering at the display.

### BRIEF DESCRIPTION OF THE DRAWINGS

FIG. 1 illustrates a system block diagram of an XR device, according to an embodiment.

FIG. 2 is a diagram to illustrate a process to track eye data and generate an updated projection, according to an embodiment.

FIGS. 3A-3C are diagrams that illustrate examples of intended depth estimations matching actual depths of some objects but not other objects, according to an embodiment.

FIGS. 4A-4G are diagrams that illustrate a processing pipeline, according to an embodiment.

FIGS. 5A-5E are diagrams that illustrate the effects of various camera-display distances.

FIG. 6 is a diagram that illustrates the effects of a fixed Z-distance.

FIG. 7 is a diagram that illustrates the effects of a fixed Z-distance where the camera FOV is larger than the display FOV.

FIGS. 8A and 8B are images that illustrate an example of a camera fully covering a FOV and a camera not fully covering a FOV, respectively.

FIGS. 9A-9J are diagrams that illustrate various examples of the amount of FOV visibility/missing information at varying camera FOV, display FOV, and Z positions.

FIG. 10 is a flowchart of a method 1000 to update a rendering based on estimated depths, according to an embodiment.

### DETAILED DESCRIPTION

Some implementations described herein relate to using eye tracking and depth estimation to enhance a user's experience with XR devices. Eye tracking systems capture real-time data about the user's gaze, including metrics like vergence angles and pupillary responses. This information is used to determine the user's intent and the depth plane the user is focusing on. Depth estimation complements this process by using visual data collected from one or more cameras, which is then analyzed by artificial intelligence (AI) models to calculate the physical depth of objects in the user's field of view (FOV). By comparing the user's focal depth, derived from eye tracking data, with the physical depth of these objects (e.g., determined using the AI models), the XR system can provide feedback and adjust the rendering to better match the user's perspective.

To ensure accurate monocular and/or binocular depth rendering, some implementations adjust binocular disparity (e.g., the difference between the left eye and an object and the difference between the right eye and the object) and/or monocular disparity (e.g., the difference between the object and one of the left or right eye). This alignment reduces visual discomfort by ensuring that rendered content conforms to the user's natural vergence patterns. Visual cues like graduated blur effects, which mimic the natural depth of field, further improve perceptual accuracy and create a more immersive experience. In response to image data being captured by a camera(s) (e.g., monocular or binocular monochrome camera) at the XR device, some implementations use machine learning (ML) to process telemetry data from the eye tracking systems to estimate focal depth for a pixel(s) of interest (gaze) and guide adjustments to rendered content of the image data in real time.

Some implementations include sensor-display positioning and/or calibration. Using, for example, inertial-visual tracking with six degrees of freedom, sensors and displays can be aligned to account for movement and provide feedback. Calibration techniques/mechanisms allow the system to adapt to individual differences in interpupillary distance (IPD) and vergence patterns, tailoring the XR experience to each user. By performing calibration multiple times, the device can dynamically adjust to eye movement behaviors, further improving accuracy, adaptability, and responsiveness over time.

Real-time gaze analysis enables the XR device to dynamically modify rendering pipelines (e.g., eye tracking pipeline) based on the user's focal depth. The displacement of cameras relative to displays at the XR device and/or the disparity between left and right eye views can be adjusted to maintain alignment between rendered visuals and the user's gaze. To update these depth estimations, repeated (e.g., continuous, periodic, sporadic, random) feedback from users can be used to train ML models, enhancing system performance with repeated interactions. Additionally, repeated (e.g., continuous, periodic, sporadic, random) monitoring of eye convergence patterns can help detect attention points and ensures that visual content is/remains synchronized with the user's gaze, reducing visual discomfort.

Environmental conditions, such as lighting, which affect pupillary responses, can also be considered in some implementations. For example, an XR device can compensate for such conditions to maintain substantially consistent depth estimation. Pass-through rendering pipelines can dynamically adapt rendered content to align with the user's gaze under changing environmental conditions (e.g., increased brightness, decreased brightness). Additionally or alternatively, foveated rendering techniques can be used to enhance immersion by prioritizing visual fidelity at the user's focal depth while conserving resources by reducing detail in peripheral areas.

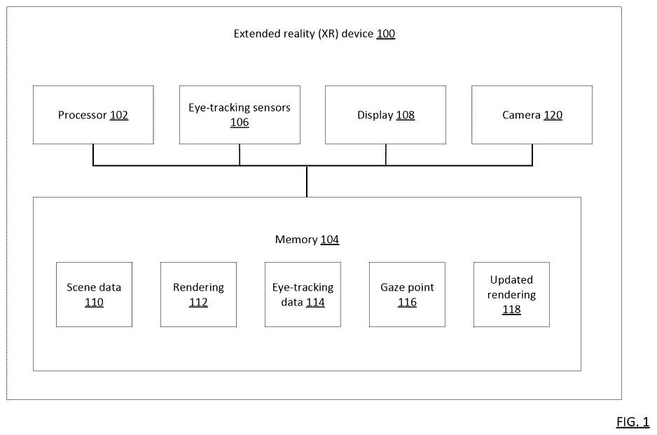

FIG. 1 illustrates a system block diagram of an XR device 100, according to an embodiment. XR device 100 can be, for example, a virtual reality (VR) headset, an augmented reality (AR) headset, mixed reality (MR) headset, and/or the like. In some implementations, XR device 100 is a helmet mounted display, such as the helmet mounted display disclosed in U.S. patent application Ser. Nos. 19/072,793 and/or 19/049,754, which are each incorporated herein by reference. XR device 100 includes processor 102, eye-tracking sensors 106, display 108, cameras 120, and memory 104, each operatively coupled to one another (e.g., via a system bus). In some implementations, XR device 100 does not include and/or receive data from a time-of-flight sensor.

Processor 102 can be, for example, a hardware-based integrated circuit (IC) or any other suitable processing device configured to run or execute a set of instructions or a set of codes. For example, processor 102 can include a general purpose processor, a central processing unit (CPU), an accelerated processing unit (APU), an application specific integrated circuit (ASIC), a field programmable gate array (FPGA), a programmable logic array (PLA), a complex programmable logic device (CPLD), a programmable logic controller (PLC), a graphics processing unit (GPU), a neural network processor (NNP), and/or the like. Processor 102 can be operatively coupled to memory 104 through a system bus (for example, address bus, data bus, and/or control bus). Memory 104 can store electronic information. The term memory may refer to various types of processor-readable media such as, for example, random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc.

Eye-tracking sensors 106 can include one or more eye tracking sensors. When a user is wearing XR device 100, eye tracking sensors 106 can measure eye movements, positions, and/or gaze direction of one or both eyes of the user to gather data indicating where a person is looking and how their eyes interact with visual stimuli. In some implementations, eye-tracking sensors 106 are cameras. In some implementations, eye-tracking sensors 106 includes a first camera being a first type (e.g., monochrome camera) and a second camera being a second type (e.g., color camera) different than the first type.

Display 108 is an interface through which a user wearing XR device 100 can experience virtual, augmented, or mixed environments. Display 108 can be, for example, for organic light-emitting diode (OLED) display, liquid crystal display (LCD), microLED display, and/or the like. Display 108 can display in color and/or grayscale.

Cameras 120 can include one or more cameras. In some implementations, cameras 120 is mounted on XR device 100 and faces outwards to capture image/video data of a surrounding scene (where the scene is the physical world). Cameras 120 can include any type of camera, such as monochrome camera or a color camera. In some implementations, cameras 120 includes a thermal camera. In some implementations, where cameras 120 includes a thermal camera, thermal data captured by cameras 120 is enhanced using the image enhancement techniques described in U.S. Provisional Patent Application No. 63/789,208, titled “Systems and Methods for Thermal Imaging Enhancement” and filed on Apr. 15, 2025, which is incorporated herein by reference in its entirety.

Memory 104 includes (e.g., stores) scene data 110. Scene data 110 represents to the visual information captured by cameras 120 in the form of an image or video, depicting the physical environment (including objects at the physical environment). Scene data 110 can include, for example, details like colors, shapes, lighting, and spatial relationships between objects within the scene. In some implementations, a depth between an object at the scene represented by scene data 110 and cameras 120 can be estimated/determined based on scene data 110 (e.g., using monocular depth estimation, stereo vision, triangulation, and/or the like).

Memory 104 also includes (e.g., stores) rendering 112. Rendering 112 represents a digital image or visual output of the scene represented by scene data 110. Scene data 110 is processed and transformed into rendering 112, where rendering 112 represents a more realistic or stylized representation of the scene captured by cameras 120. In response to generating rendering 112, rendering 112 can be displayed at display 108 so that a user wearing XR device 100 can view rendering 112.

Memory 104 also includes (e.g., stores) eye-tracking data 114. Eye-tracking data 114 can represent data collected by eye-tracking sensors 106 of at least one eye of a user wearing XR device 100. Thus, eye-tracking sensor 106 can be configured to capture data about the eye(s) of the user wearing XR device 100 to generate eye-tracking data 114. Eye-tracking data 114 can include, for example, pupil position, gaze direction, blink rate, eye movement patterns, and/or etc. In some implementations, eye-tracking data 114 is timestamped to indicate when certain data (e.g., pupil position, gaze direction, blink rate, eye movement patterns, and/or etc.) was captured.

Memory 104 also includes (e.g., stores) gaze point 116. Gaze point 116 can include one or more gaze points. Where gaze point 116 includes multiple gaze points, each gaze point can be associated with (e.g., captured at) a time from a period of time (e.g., a first gaze point was captured at a first time, a second gaze point was captured at a second time, etc.). Gaze point 116 can refer to, for example, the specific location(s) in space or on a surface where the user's eye(s) is directed at a moment in time and/or over a period of time. In some implementations, gaze point 116 of the tracked eye(s) can be determined/estimated based on eye-tracking data 114.

For example, if two eyes are being analyzed, the gaze of each eye is determined (e.g., using eye-tracking data 114) and represented as a vector and gaze point 116 is estimated based on depth information contained in the two vectors.

In some implementations, a depth(s) between the tracked eye(s) and gaze point 116 is determined based on eye-tracking data 114 and a focal depth of the tracked eye(s). For example, the depth(s) can be estimated by analyzing the gaze direction and determining a vergence angle that indicates where the gaze lines from the track eye(s) intersect. Using a function of the vergence angle with the focal depth of the tracked eye(s), the depth can be determined.

Memory 104 also includes (e.g., stores) updated rendering 118. Updated rendering 118 can be generated based on a comparison of (1) the depth between the object at the scene represented by scene data 110 and cameras 120 and (2) depth(s) between the tracked eye(s) and gaze point 116. The comparison can be used to determine if there is vergence accommodation conflict (e.g., when the eyes' vergence and accommodation give conflicting cues). If there is vergence accommodation conflict, updated rendering 118 can be generated by updating rendering 112 based on the comparison to avoid the vergence accommodation conflict. Updated rendering 118 can be displayed at display 108.

In some implementations, updated rendering 118 includes all the same objects as rendering 112, but at different focuses, blurs, locations, shapes, and/or orientations. In some implementations, updated rendering 118 includes an object not included in rendering 112. In some implementations, updated rendering 118 does not include an object included in rendering 112.

In some implementations, the depth estimation, gaze analysis, and rendering update operations described herein are performed by processor 102 in real time (e.g., at or above a display refresh rate of display 108) such that updated rendering 118 is generated and displayed substantially contemporaneously with the user's viewing of the scene. The computational throughput required to receive scene data 110, estimate depths, process eye-tracking data 114 and gaze point 116, and generate updated rendering 118 within each rendering cycle (e.g., within milliseconds) operates at machine speed and is beyond that which a human(s) could practically perform. Accordingly, the real-time, processor-driven nature of these operations enables XR device 100 to dynamically adapt rendered content to the user's gaze as the user views the scene, providing a responsive and perceptually accurate experience that would not be achievable through manual or human-performed calculations.

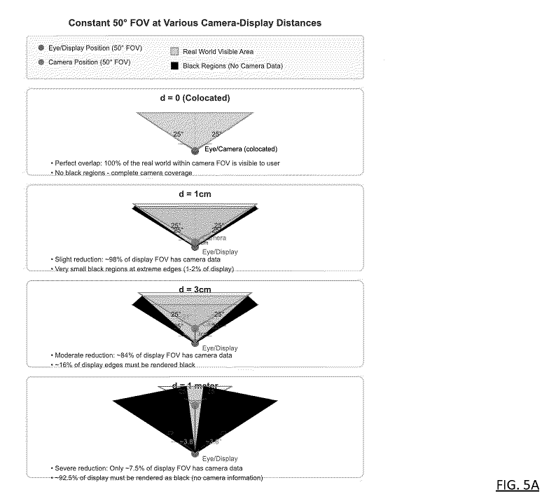

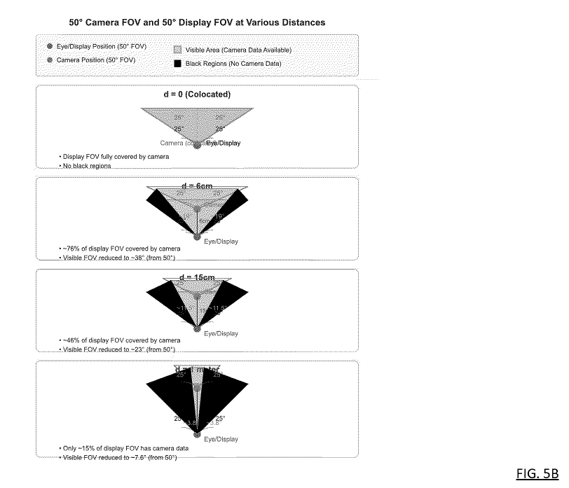

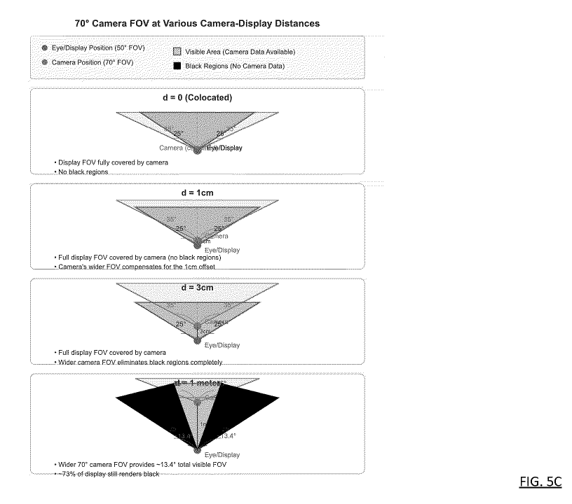

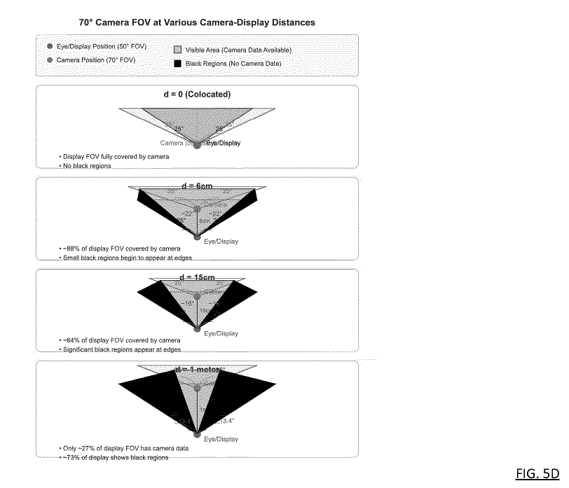

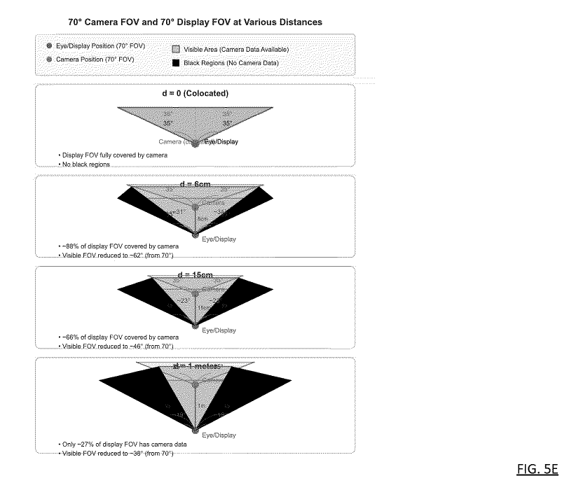

Some implementations described herein are directed to improving the functioning of XR device 100. For example, techniques described herein mitigate (e.g., resolve) accommodation-vergence conflict that can arise from the physical architecture of XR headsets, where a user's eyes view rendered content on display 108 at a fixed optical distance while attempting to focus on objects depicted at varying virtual depths. As another example, the spatial displacement between cameras 120 and display 108 on XR device 100 introduces parallax and field-of-view coverage challenges (see, e.g., FIGS. 5A-9J) that techniques described herein can mitigate (e.g., resolve). By integrating eye-tracking sensors 106, cameras 120, display 108, and processor 102 on a single wearable device and coordinating their operation through the techniques described herein-in which eye-tracking data 114 and scene data 110 are repeatedly fused to generate updated rendering 118-XR device 100 dynamically adapts rendered content to the user's natural gaze and vergence behavior. This integrated approach improves the perceptual accuracy and visual comfort provided by XR device 100 while also reducing hardware complexity by, for example, not using a time-of-flight sensor that would otherwise increase device weight, size, and/or cost.

Although FIG. 1 illustrates a single device, in other implementations, the functionalities of XR device 100 can be divided across multiple devices. For example, a first compute device can include eye-tracking sensors 106 and camera 120 while a second compute device includes display 108.

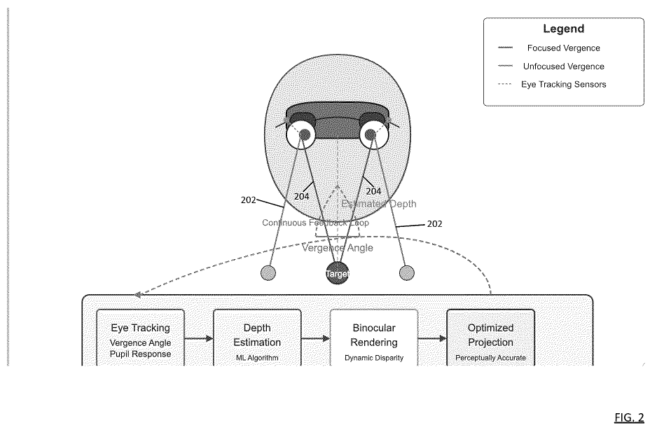

FIG. 2 is a diagram to illustrate a process to track eye data and generate an updated projection, according to an embodiment. Eye tracking is performed (e.g., using eye-tracking sensors 106) to analyze a pupil response and determine a focused vergence angle and unfocused vergence angle. For example, the outer lines 202 from the user's eyes represent an example of unfocused vergence, while the inner lines 204 from the user's eyes towards the target represent an example of focused vergence. A machine learning (ML) model can then be used to perform depth estimation based on the eye-tracking data. A binocular rendering can be generated and projected (e.g., at display 108). Such an aforementioned process of eye tracking, depth estimation, rendering, and projection can be performed repeatedly (e.g., continuously, sporadically, periodically, randomly). In some implementations, the ML model is trained using one or more training datasets, and in some instances can also be validated and/or tested using separate datasets. The training, testing, and/or validating datasets can include augmented data generated by applying one or more data-augmentation techniques to existing data for use in training, validation, and/or testing. ML model training can further include a feedback process in which output errors, misclassifications, or other performance indicators are provided back to the ML model as inputs to iteratively update model parameters and improve learning. While catastrophic learning effects (e.g., catastrophic forgetting) can occur during known ML model training, in some implementations of FIG. 2, such effects can be mitigated using, for example, constrained parameter updates, retention or replay of prior training data or representations, staged or partial model updates, regularization techniques, or other learning-stability controls.

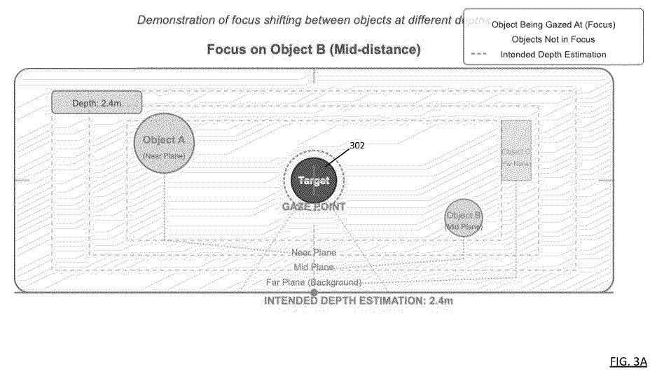

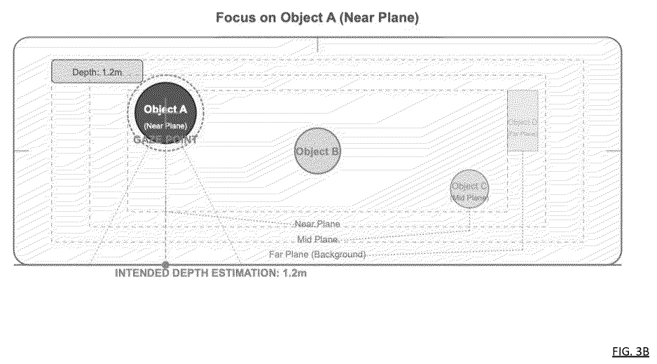

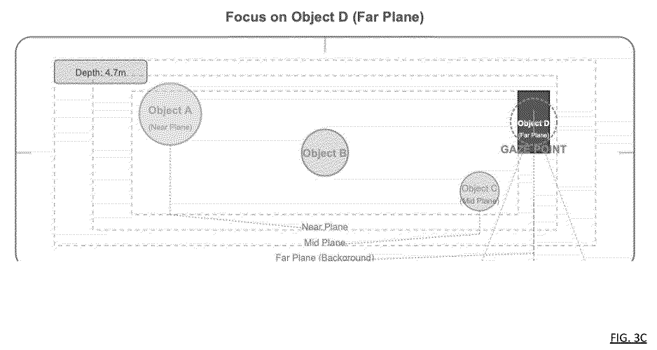

FIGS. 3A, 3B, and 3C are diagrams that illustrate examples of intended depth estimations matching actual depths of some objects but not other objects, according to an embodiment. FIG. 3A illustrates a target 302 having a depth of 2.4 meters and the intended depth estimation also having 2.4 meters. (Note the “target” here is an object that is intended to be viewed by the user.) Thus, when rendered, the target 302 appears in focus while Objects A, B, and C do not appear in focus. FIG. 3B illustrates Object A having a depth of 1.2 meters and the intended depth estimation also having 1.2 meters. Thus, when rendered, Object A appears in focus while Objects B, C, and D do not appear in focus. FIG. 3C illustrates Object D having a depth of 4.7 meters and the intended depth estimation also having 4.7 meters. Thus, when rendered, Object D appears in focus while Objects A, B, and C do not appear in focus. FIGS. 3A, 3B, and 3C illustrate how the depth at which a user is focusing can be determined by combining gaze location with eye-convergence information, even when multiple objects are present at different distances within the field of view. Several objects can be at distinct depth planes (e.g., near plane, mid plane, far plane) while remaining simultaneously visible. FIGS. 3A, 3B, and 3C show different gaze scenarios in which the user's gaze point shifts between objects, and the eye-tracking system measures the corresponding convergence angles of the user's eyes. Using this convergence information together with knowledge of the scene depth, the system can estimate the user's intended focal depth, producing a near-depth estimate when the gaze is directed to an object that is in the near plane, a mid-depth estimate when focusing on an object in the mid plane, and a far-depth estimate when focusing on an object in the far plane.

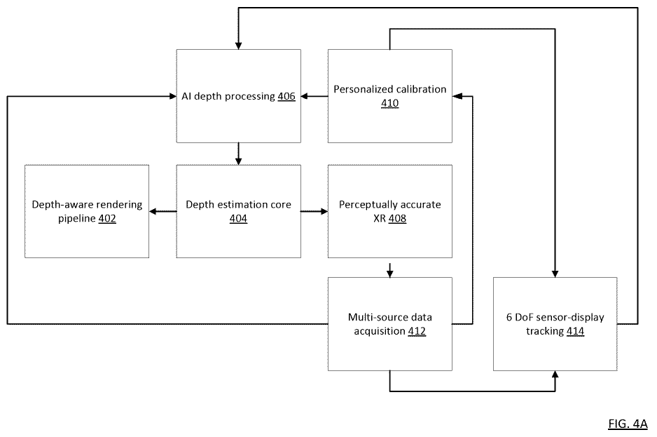

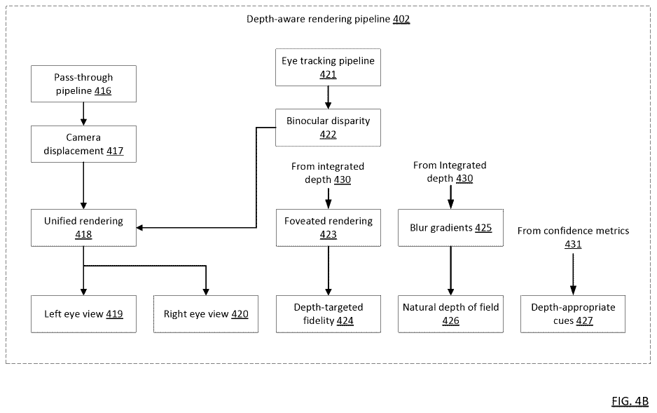

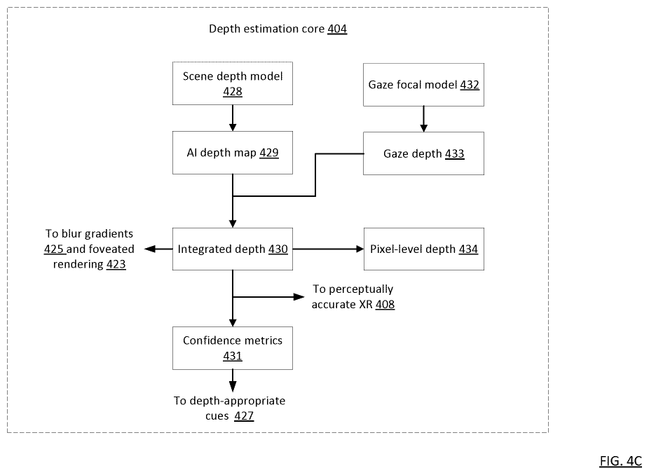

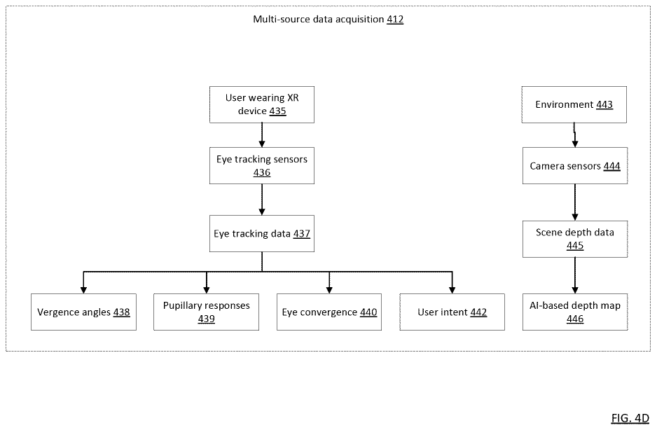

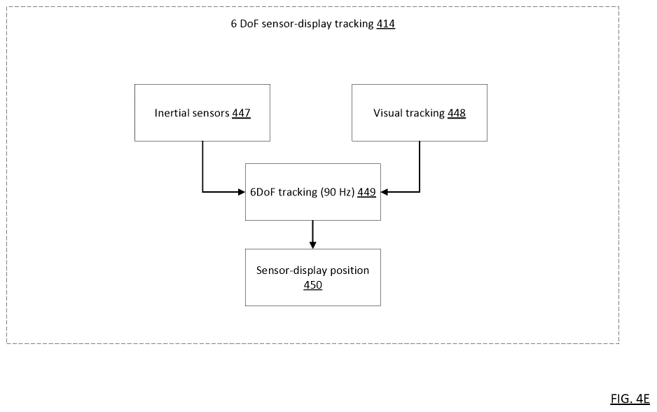

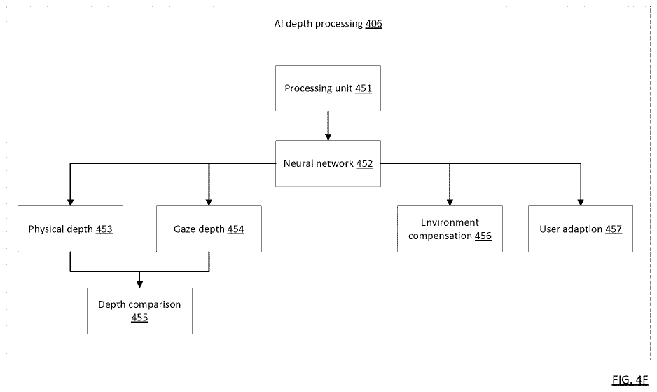

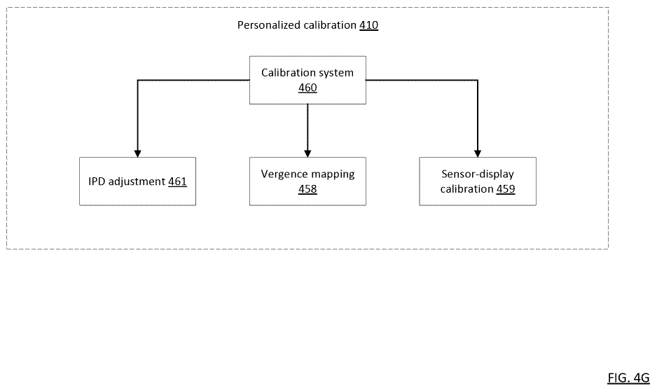

FIGS. 4A-4G are diagrams that illustrate a processing pipeline, according to an embodiment. FIG. 4A illustrates depth-aware rendering pipeline 402 connected to depth estimation core 404. Depth-aware rendering pipeline 402 occurs in response to depth estimation core 404. Depth estimation core 404 occurs in response to AI depth processing 406. Perceptually accurate XR 408 occurs in response to depth estimation core 404. Personalized calibration 410 occurs in response to multi-source data acquisition 412. AI depth processing 406 occurs in response to multi-source data acquisition 412 and 6 degrees of freedom (Dof) sensor-display tracking 414. Multi-source data acquisition 412 occurs in response to perceptually accurate XR 408. 6 DoF sensor-display tracking 414 occurs in response to multi-source data acquisition 412.

FIG. 4B illustrates additional details regarding depth-aware rendering pipeline 402. Eye tracking pipeline 421 generates binocular disparity 422 (e.g., based on measured gaze and vergence information). Before, after, and/or in parallel, pass-through pipeline 416 generates camera displacement 417, where camera displacement 417 represents parameters that compensate for positional differences between world-facing cameras (e.g., camera 120) and displays (e.g., display 108). Unified rendering 418 is generated based on camera displacement 417 and binocular disparity 422. Unified rendering 418 is used to generate left eye view 419 and right eye view 420, where left eye view 419 and right eye view 420 can be the same or be different. Foveated rendering 423 and blur gradients 425 are generated based on integrated depth 430 (illustrated at FIG. 4C). Foveated rendering 423 generates depth-targeted fidelity 424 by allocating higher rendering quality to regions near the estimated focus depth. Blur gradients 425 is used to generate natural depth of field 426. Depth-appropriate cues 427 are generated based on confidence metrics 431 (illustrated at FIG. 4C), allowing the system to adapt rendering strategies based on the confidence/reliability of depth estimates.

FIG. 4C illustrates additional details regarding depth estimation core 404. Scene depth model 428 connects to or outputs AI depth map 429 representing physical depth within the observed environment. Gaze focal model 432 connects to or outputs gaze depth 433, representing the depth at which the user is estimated to be focusing based on eye-tracking signals. Gaze depth 433 and AI depth map 429 are used to determine integrated depth 430, which can represent a reconciled or fused depth estimate that accounts for both environmental structure and user gaze behavior. Integrated depth 430 is used to determine pixel-level depth 434, blur gradients 425, foveated rendering 423, perceptually accurate XR 408, and confidence metrics 431. Confidence metrics 431, reflecting the certainty of the depth estimation. are used to determine depth-appropriate cues 427.

FIG. 4D illustrates additional details regarding multi-source data acquisition 412, according to an embodiment. User wearing XR device 435 is tracked by eye tracking sensors 436. Eye tracking sensors 436 output data used to determine eye tracking data 437. Eye tracking data 437 is used to determine vergence angles 438 (e.g., by tracking the pupil center or corneal reflection of each eye, fitting a gaze vector per eye, and/or calculating the angle between the two vectors), pupillary responses 439 (e.g., by capturing the pupil diameter in real time, where changes in pupil size can correlate with accommodation (e.g., focus distance), cognitive load, and/or lighting conditions), eye convergence 440, and user intent 442 (e.g., by analyzing fixation on an object beyond a predefined threshold, using an ML model trained to predict user intent, and/or the like). Environment 443 is observed/detected by camera sensors 444. Camera sensors 444 output data used to determine scene depth data 445. Scene depth data 445 is input into an AI model to produce AI-based depth map 446.

FIG. 4E illustrates additional details regarding 6 DoF sensor-display tracking 414, according to an embodiment. Inertial sensors 447 and visual tracking 448 each provide data used to determine 6 DoF tracking (90 Hz) 449. 6 DoF tracking (90 Hz) 449 is used to determine sensor-display position 450, enabling accurate spatial alignment between captured sensor data and rendered imagery.

FIG. 4F illustrates additional details regarding AI depth processing 406, according to an embodiment. Processing unit 451 is used to operate an AI model such as neural network 452.

Neural network 452 provides output related to/determines physical depth 453, gaze depth 454, environment compensation 456, and user adaption 457. Physical depth 453 and gaze depth 454 are compared to one another to determine depth comparison 455. Depth comparison 455 can be used, for example, to resolve discrepancies between scene geometry and user focus behavior.

FIG. 4G illustrates additional details regarding personalized calibration 410, according to an embodiment. Calibration system 460 determines IPD adjustment 461, vergence mapping 458, and sensor-display calibration 459. IPD adjustment 461, vergence mapping 458, and/or sensor-display calibration 459 can be used to confirm and/or modify depth estimation, eye-tracking interpretation, and/or rendering behavior to individual users, thereby improving depth accuracy, visual comfort, and realism.

FIGS. 5A-5E are diagrams that illustrate the effects resulting from various camera-display distances. As illustrated at FIGS. 5A and 5B, where the camera has a 50 degree FOV and the eye/display position also have a 50 degree FOV, the camera captures less of the real world visible area as the difference between the camera distance and display distance get larger. In contrast, when the difference between the camera distance and display distance is 0, the camera captures the entire real world visible area. FIGS. 5C and 5D illustrate the camera having a 70 degree FOV and eye/display position of 50 degree FOV. Because the camera FOV is larger than the eye/display position FOV, the camera captured the full visible area when the distance is 0, 1, and 3 centimeter (cm). As the distance increases, however (e.g., d=1 meter, d=4 meters, and/or the like), the camera captures less of the visible area. FIG. 5E illustrates the camera having a 70 degree FOV and eye/display position of 70 degree FOV. As illustrated, the camera captures less of the real world visible area as the difference between the camera distance and display distance get larger. In contrast, when the difference between the camera distance and display distance is 0, the camera captures the entire real world visible area.

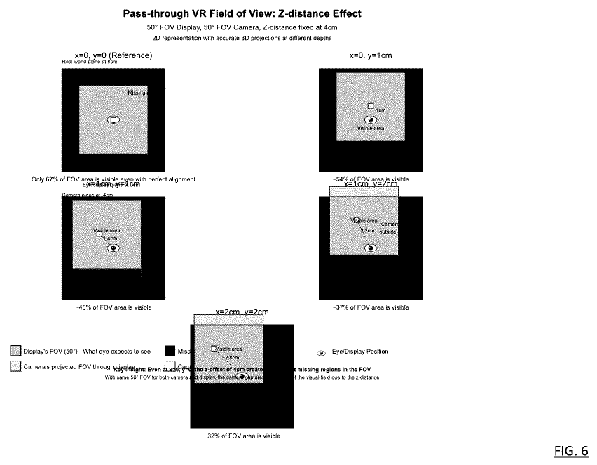

FIG. 6 is a diagram that illustrates the effects of a fixed Z-distance. As illustrated, when the Z-distance is fixed at 4 cm, the display FOV is 50 degrees, and the camera FOV is 50 degrees, the FOV area is most visible when the eye/display position matches the camera position. Because of the z-distance, however, the full FOV area is not visible. As the distance between the eye/display position and camera position increases, the amount of visible FOV area decreases too. This visible FOV area reduction occurs because lateral offsets amplify the parallax mismatch, causing progressively larger regions of the camera-captured scene to fall outside the user's effective display field of view. Accordingly, FIG. 6 demonstrates that a fixed Z-distance without dynamic reprojection or compensation results in loss of visible content and degraded visual coverage, underscoring the desire for depth-aware reprojection that accounts for eye position and sensor-display geometry.

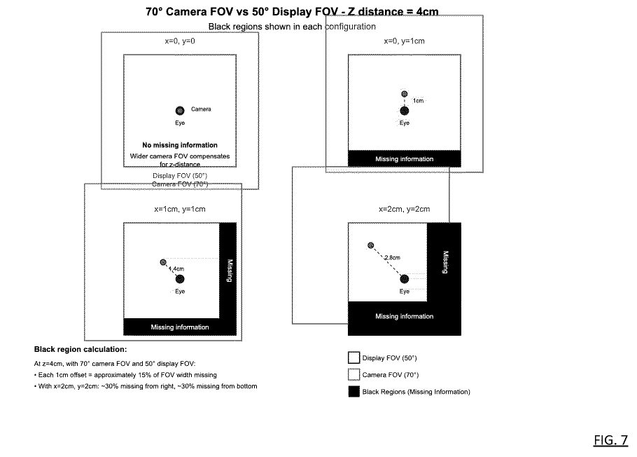

FIG. 7 is a diagram that illustrates the effects of a fixed Z-distance. Here, the camera FOV is larger than the display FOV. Like FIG. 6, the Z-distance is fixed at 4 cm. Unlike FIG. 6, however, the camera FOV (70 degrees) is larger than the display FOV (50 degrees). When the eye/display position matches the camera position, the wider camera FOV compensates for the Z-distance and captures the full area. As the distance increases, however, information is missed.

Specifically, lateral displacement causes portions of the camera-captured field of view to fall outside the narrower display field of view, resulting in missing visual information. As such, FIG. 7 illustrates that increasing camera field of view can mitigate, but will not eliminate, missing information when a fixed Z-distance is present.

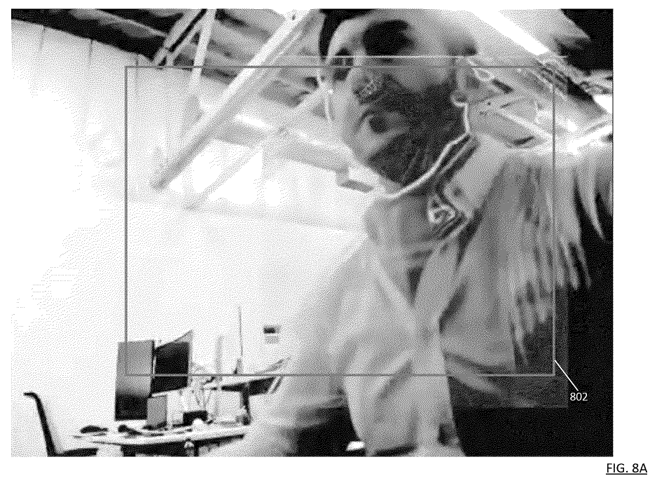

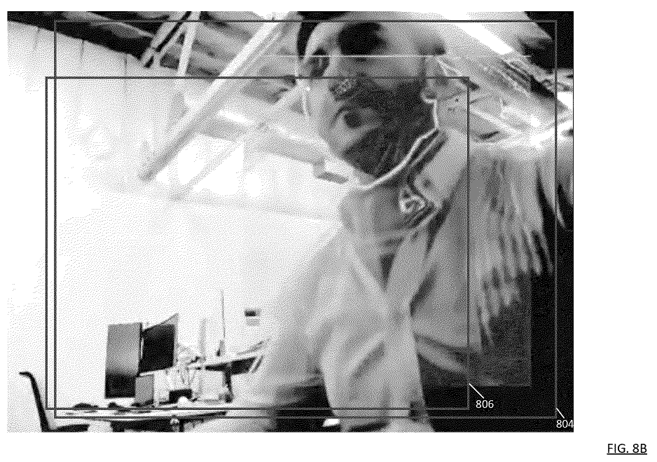

FIG. 8A is a diagram that illustrates an example of a camera fully covering a FOV. Box 802 represents the area captured by the camera data and display FOV. As illustrated, the camera data and display FOV cover the same area (as defined by box 802). In contrast, FIG. 8B is a diagram that illustrates an examples of displaying only a portion of an image due to missing information. Box 804 represents what the camera data captures while box 806 represents the display FOV. As illustrated, box 806 is smaller than box 804, meaning that information is missing and not captured in the camera data.

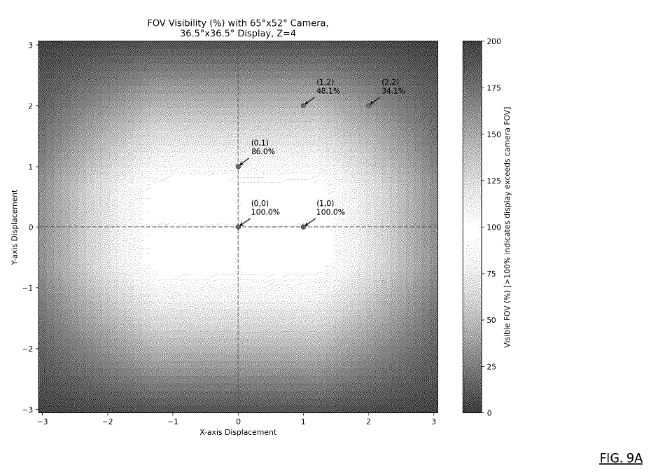

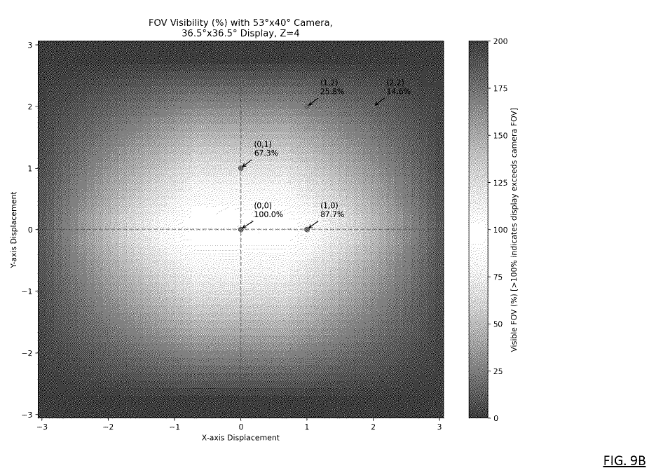

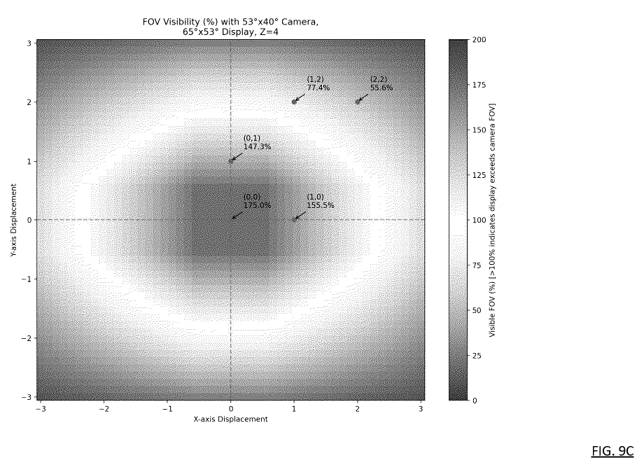

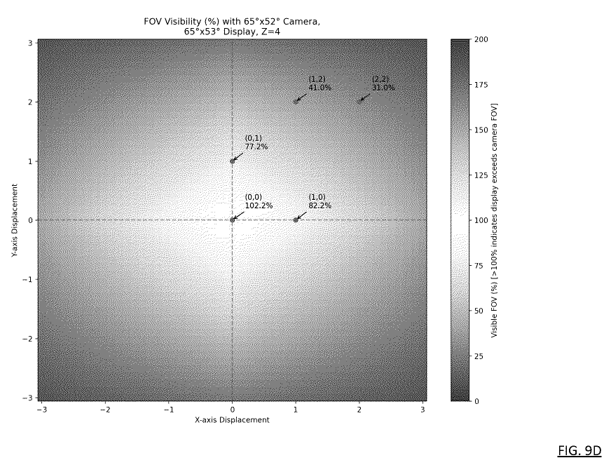

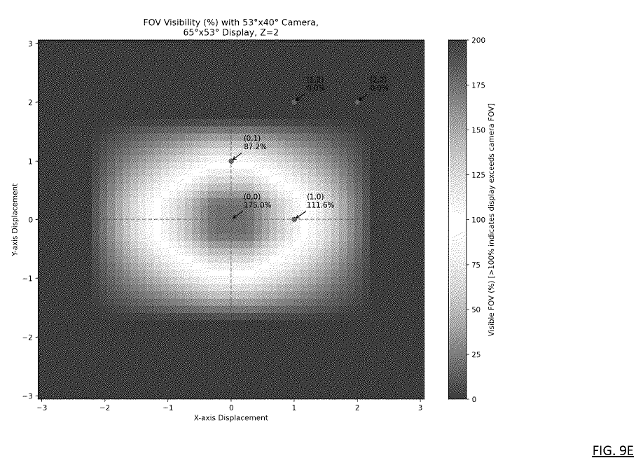

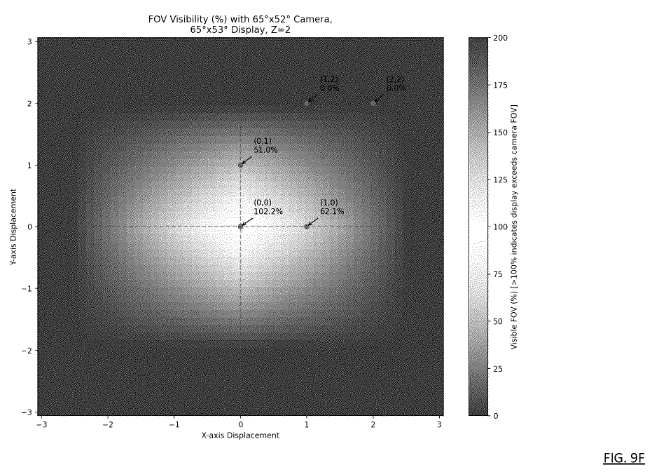

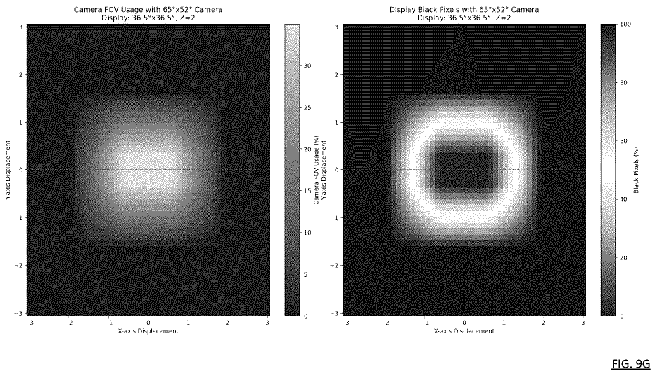

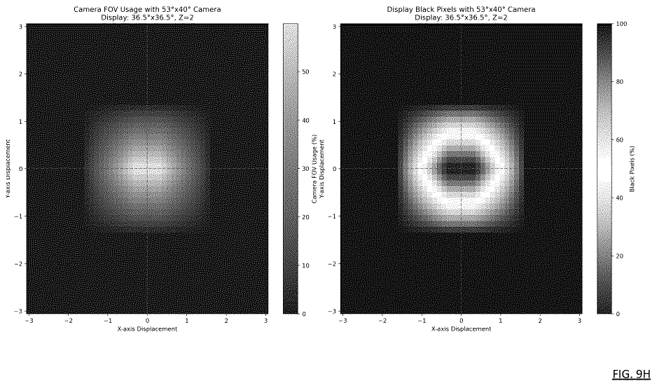

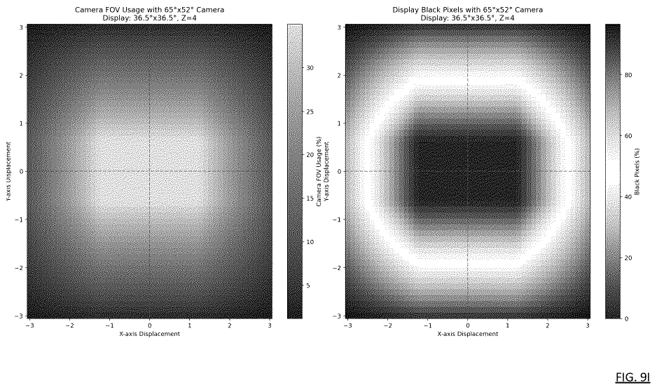

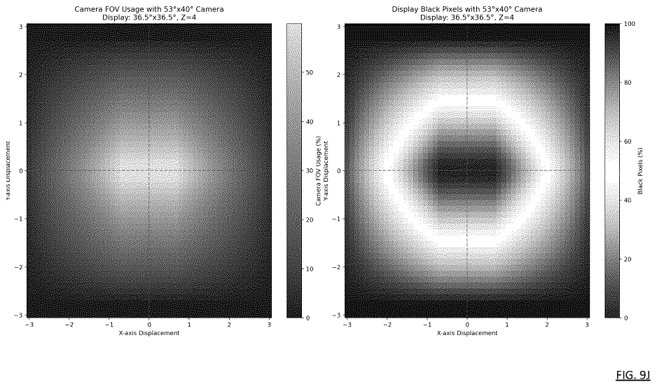

FIGS. 9A-9J are diagrams that illustrate various examples of the amount of FOV visibility/missing information at varying camera FOV, display FOV, and Z positions. As illustrated, the amount of visibility varies based on how the FOVs and Z positions are varied. Some techniques described herein can repeatedly update renderings such that the amount of missed information is reduced (e.g., minimized).

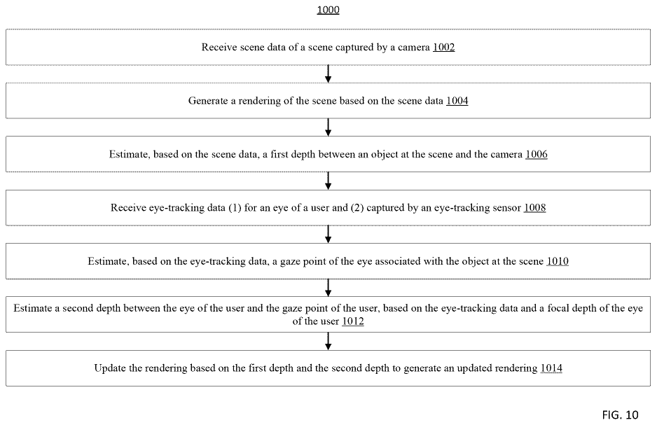

FIG. 10 is a flowchart of a method 1000 to update a rendering based on estimated depths, according to an embodiment. In some implementations, method 1000 is performed by a processor (e.g., processor 102 of FIG. 1).

At 1002, scene data (e.g., scene data 110) of a scene captured by a camera (e.g., camera 120) is received. At 1004, a rendering (e.g., rendering 112) of the scene is generated based on the scene data. At 1006, a first depth between an object at the scene and the camera is estimated based on the scene data. At 1008, eye-tracking data (e.g., eye-tracking data 114) (1) for an eye of a user and (2) captured by an eye-tracking sensor (e.g., eye-tracking sensors 106) is received. At 1010, a gaze point (e.g., gaze point 116) of the eye associated with the object at the scene is estimated based on the eye-tracking data. At 1012, a second depth between the eye of the user and the gaze point of the user is estimated based on the eye-tracking data and a focal depth of the eye of the user. At 1014, the rendering is updated based on the first depth and the second depth to generate an updated rendering (e.g., updated rendering 118).

In some implementations of method 1000, the object is a first object, and a third depth between a second object at the scene and the camera is estimated based on the scene data. The rendering at 1014 can further be updated based on a comparison of the third depth and the second depth to generate the updated rendering. The updated rendering does not include the second object.

In some implementations of method 1000, the object is a first object and a third depth between a second object at the scene and the camera is estimated based on the scene data. The rendering at 1014 can further be updated based on a comparison of the third depth and the second depth to generate the updated rendering. The updated rendering (1) renders the first object at a first focus and (2) render the second object at a second focus different than the first focus.

In some implementations of method 1000, the object is a first object, a confidence value associated with the first depth is determined, and a confidence value associated with the second depth is determined. The rendering at 1014 can further be updated based on the confidence value associated with the first depth and the confidence value associated with the second depth.

In a first embodiment, an XR headset (e.g., XR device 100) includes a set of eye-tracking sensors (e.g., eye-tracking sensors 106), a set of cameras (e.g., camera 120), a display (e.g., display 108), a memory (e.g., memory 104), and a processor (e.g., processor 102) operatively coupled to at least one of the set of eye-tracking sensors, the set of cameras, the display, or the memory. The processor is configured to receive scene data (e.g., scene data 110) of a scene captured by the set of cameras during a time period. The processor is further configured to generate a rendering (e.g., rendering 112) of the scene at the display based on the scene data. The processor is further configured to estimate a first depth between an object at the scene and the set of cameras, based on the scene data. The processor is further configured to receive eye-tracking data (e.g., eye-tracking data 114) (1) for at least one eye of a user and (2) captured by the set of eye-tracking sensors during the time period. The processor is further configured to estimate a gaze point (e.g., gaze point 116) of the at least one eye during the time period and associated with the object at the scene, based on the eye-tracking data. The processor is further configured to estimate a second depth between the at least one eye of the user and the gaze point of the user, based on the eye-tracking data and a focal depth of the at least one eye of the user. The processor is further configured to update the rendering based on a comparison of the first depth and the second depth to generate an updated rendering (e.g., updated rendering 118) at the display. In some implementations, the extended reality headset does not include a time-of-flight sensor. In some implementations, the updated rendering is displayed via foveated rendering.

In some implementations of the first embodiment, the object is a first object and the processor is further configured to estimate a third depth between a second object at the scene and the set of cameras, based on the scene data. The rendering is further updated based on a comparison of the third depth and the second depth. Thus, the updated rendering can be updated based on multiple different depths for multiple different objects. In some implementations, the updated rendering does not include the second object. In some implementations, the updated rendering renders the first object at a first focus and renders the second object at a second focus different than the first focus.

In some implementations of the first embodiment, the at least one eye includes a first eye and a second eye, and the processor is configured to, when estimating the gaze point, perform a process that includes determining a vector associated with the first eye, determining a vector associated with the second eye, and determining, using a machine learning model, the gaze point based on the vector associated with the first eye and the vector associated with the second eye. In some implementations, the machine learning model is updated based on the gaze point.

In some implementations of the first embodiment, the XR headset does not include a time-of-flight sensor. In some implementations, the updated rendering is displayed via foveated rendering.

In a second embodiment, a method (e.g., performed by processor 102) includes receiving, via a processor (e.g., processor 102), scene data (e.g., scene data 110) of a scene captured by a camera (e.g., camera 120) during a time period. The method further includes generating, via the processor, a rendering (e.g., rendering 112) of the scene at a display based on the scene data. The method further includes estimating, via the processor, a first depth between an object at the scene and the camera, based on the scene data. The method further includes receiving, via the processor, eye-tracking data (e.g., eye-tracking data 114) (1) for an eye of a user and (2) captured by an eye-tracking sensor (e.g., eye tracking sensors 106) during the time period. The method further includes estimating, via the processor, a gaze point (e.g., gaze point 116) of the eye during the time period and associated with the object at the scene, based on the eye-tracking data. The method further includes estimating, via the processor a second depth between the eye of the user and the gaze point of the user, based on eye-tracking data and a focal depth of the eye of the user. The method further includes updating, via the processor, the rendering based on a comparison of the first and the second depth to generate an updated rendering (e.g., updated rendering 118) at the display.

Some implementations of the second embodiment further include determining a confidence value associated with the first depth, and determining a confidence value associated with the second depth. Updating the rendering to generate the updated rendering can further be based on the confidence value associated with the first depth and the confidence value associated with the second depth.

In some implementations of the second embodiment, the object is a first object and a third depth between a second object at the scene and the camera is estimated based on the scene data. The rendering can further be updated based on a comparison of the third depth and the second depth to generate the updated rendering.

In some implementations of the second embodiment, the object is a first object and a third depth between a second object at the scene and the camera is estimated based on the scene data. The rendering can further be updated based on a comparison of the third depth and the second depth to generate the updated rendering. The updated rendering does not include the second object.

In some implementations of the second embodiment, the object is a first object and a third depth between a second object at the scene and the camera is estimated based on the scene data. The rendering can further be updated based on a comparison of the third depth and the second depth to generate the updated rendering. The updated rendering can render the first object at a first focus and render the second object at a second focus different than the first focus.

In some implementations of the second embodiment, the eye is a first eye, the user has a second eye, and estimating the gaze point includes determining a vector associated with the first eye, determining a vector associated with the second eye, and determining, using a machine learning model, the gaze point based on the vector associated with the first eye and the vector associated with the second eye. Some implementations of the second embodiment further include updating the machine learning model based on the gaze point.

Some implementations of the second embodiment further include displaying the updated rendering via foveated rendering.

Combinations of the foregoing concepts and additional concepts discussed here (provided such concepts are not mutually inconsistent) are contemplated as being part of the subject matter disclosed herein. The terminology explicitly employed herein that also may appear in any disclosure incorporated by reference should be accorded a meaning most consistent with the particular concepts disclosed herein.

The skilled artisan will understand that the drawings primarily are for illustrative purposes, and are not intended to limit the scope of the subject matter described herein. The drawings are not necessarily to scale; in some instances, various aspects of the subject matter disclosed herein may be shown exaggerated or enlarged in the drawings to facilitate an understanding of different features. In the drawings, like reference characters generally refer to like features (e.g., functionally similar and/or structurally similar elements).

To address various issues and advance the art, the entirety of this application (including the Cover Page, Title, Headings, Background, Summary, Brief Description of the Drawings, Detailed Description, Embodiments, Abstract, Figures, Appendices, and otherwise) shows, by way of illustration, various embodiments in which the embodiments may be practiced. As such, all examples and/or embodiments are deemed to be non-limiting throughout this disclosure.

It is to be understood that the logical and/or topological structure of any combination of any program components (a component collection), other components and/or any present feature sets as described in the Figures and/or throughout are not limited to a fixed operating order and/or arrangement, but rather, any disclosed order is an example and all equivalents, regardless of order, are contemplated by the disclosure.

Various concepts may be embodied as one or more methods, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments. Put differently, it is to be understood that such features may not necessarily be limited to a particular order of execution, but rather, any number of threads, processes, services, servers, and/or the like that may execute serially, asynchronously, concurrently, in parallel, simultaneously, synchronously, and/or the like in a manner consistent with the disclosure. As such, some of these features may be mutually contradictory, in that they cannot be simultaneously present in a single embodiment. Similarly, some features are applicable to one aspect of the innovations, and inapplicable to others.

The indefinite articles “a” and “an,” as used herein in the specification and in the embodiments, unless clearly indicated to the contrary, should be understood to mean “at least one.”

The phrase “and/or,” as used herein in the specification and in the embodiments, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the embodiments, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the embodiments, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of.” “Consisting essentially of,” when used in the embodiments, shall have its ordinary meaning as used in the field of patent law.

As used herein in the specification and in the embodiments, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

In the embodiments, as well as in the specification above, all transitional phrases such as “comprising,” “including,” “carrying,”“having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

Some embodiments described herein relate to a computer storage product with a non-transitory computer-readable medium (also can be referred to as a non-transitory processor-readable medium) having instructions or computer code thereon for performing various computer-implemented operations. The computer-readable medium (or processor-readable medium) is non-transitory in the sense that it does not include transitory propagating signals per se (e.g., a propagating electromagnetic wave carrying information on a transmission medium such as space or a cable). The media and computer code (also can be referred to as code) may be those designed and constructed for the specific purpose or purposes. Examples of non-transitory computer-readable media include, but are not limited to, magnetic storage media such as hard disks, floppy disks, and magnetic tape; optical storage media such as Compact Disc/Digital Video Discs (CD/DVDs), Compact Disc-Read Only Memories (CD-ROMs), and holographic devices; magneto-optical storage media such as optical disks; carrier wave signal processing modules; and hardware devices that are specially configured to store and execute program code, such as Application-Specific Integrated Circuits (ASICs), Programmable Logic Devices (PLDs), Read-Only Memory (ROM) and Random-Access Memory (RAM) devices. Other embodiments described herein relate to a computer program product, which can include, for example, the instructions and/or computer code discussed herein.

Some embodiments and/or methods described herein can be performed by software (executed on hardware), hardware, or a combination thereof. Hardware modules may include, for example, a processor, a field programmable gate array (FPGA), and/or an application specific integrated circuit (ASIC). Software modules (executed on hardware) can include instructions stored in a memory that is operably coupled to a processor, and can be expressed in a variety of software languages (e.g., computer code), including C, C++, Java™, Ruby, Visual Basic™, and/or other object-oriented, procedural, or other programming language and development tools. Examples of computer code include, but are not limited to, micro-code or micro-instructions, machine instructions, such as produced by a compiler, code used to produce a web service, and files containing higher-level instructions that are executed by a computer using an interpreter. For example, embodiments may be implemented using imperative programming languages (e.g., C, Fortran, etc.), functional programming languages (Haskell, Erlang, etc.), logical programming languages (e.g., Prolog), object-oriented programming languages (e.g., Java, C++, etc.) or other suitable programming languages and/or development tools. Additional examples of computer code include, but are not limited to, control signals, encrypted code, and compressed code.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may include a single computer-readable statement or many computer-readable statements.

While specific embodiments of the present disclosure have been outlined above, many alternatives, modifications, and variations will be apparent to those skilled in the art.

Accordingly, the embodiments set forth herein are intended to be illustrative, not limiting.

What is claimed is:

1. An extended reality headset, comprising:
a set of eye-tracking sensors;
a set of cameras;
a display;
a memory; and
a processor operatively coupled to at least one of the set of eye-tracking sensors, the set of cameras, the display, or the memory, the processor configured to:
receive scene data of a scene captured by the set of cameras during a time period;
generate a rendering of the scene at the display based on the scene data;
estimate a first depth between an object at the scene and the set of cameras, based on the scene data;
receive eye-tracking data (1) for at least one eye of a user and (2) captured by the set of eye-tracking sensors during the time period;
estimate a gaze point of the at least one eye during the time period and associated with the object at the scene, based on the eye-tracking data;
estimate a second depth between the at least one eye of the user and the gaze point of the user, based on the eye-tracking data and a focal depth of the at least one eye of the user; and
update the rendering based on a comparison of the first depth and the second depth to generate an updated rendering at the display.

2. The extended reality headset of claim 1, wherein the object is a first object and the processor is further configured to:
estimate, based on the scene data, a third depth between a second object at the scene and the set of cameras,
the rendering further updated based on a comparison of the third depth and the second depth.

3. The extended reality headset of claim 2, wherein the updated rendering does not include the second object.

4. The extended reality headset of claim 2, wherein the updated rendering renders the first object at a first focus and renders the second object at a second focus different than the first focus.

5. The extended reality headset of claim 1, wherein the extended reality headset does not include a time-of-flight sensor.

6. The extended reality headset of claim 1, wherein the at least one eye includes a first eye and a second eye, and the processor is configured to, when estimating the gaze point, perform a process that includes:
determining a vector associated with the first eye;
determining a vector associated with the second eye; and
determining, using a machine learning model, the gaze point based on the vector associated with the first eye and the vector associated with the second eye.

7. The extended reality headset of claim 6, wherein the processor is further configured to:
update the machine learning model based on the gaze point.

8. The extended reality headset of claim 1, wherein the updated rendering is displayed via foveated rendering.

9. A method, comprising:
receiving, via a processor, scene data of a scene captured by a camera during a time period;
generating, via the processor, a rendering of the scene at a display based on the scene data;
estimating, via the processor, a first depth between an object at the scene and the camera, based on the scene data;
receiving, via the processor, eye-tracking data (1) for an eye of a user and (2) captured by an eye-tracking sensor during the time period;
estimating, via the processor, a gaze point of the eye during the time period and associated with the object at the scene, based on the eye-tracking data;
estimating, via the processor, a second depth between the eye of the user and the gaze point of the user, based on the eye-tracking data and a focal depth of the eye of the user; and
updating, via the processor, the rendering based on a comparison of the first depth and the second depth to generate an updated rendering at the display.

10. The method of claim 9, further comprising:
determining a confidence value associated with the first depth; and
determining a confidence value associated with the second depth,
updating the rendering being further based on the confidence value associated with the first depth and the confidence value associated with the second depth.

11. The method of claim 9, wherein the object is a first object and the method further comprises:
estimating, based on the scene data, a third depth between a second object at the scene and the camera, the rendering further updated based on a comparison of the third depth and the second depth to generate the updated rendering.

12. The method of claim 9, wherein the object is a first object and the method further comprises:
estimating, based on the scene data, a third depth between a second object at the scene and the camera,
the rendering further updated based on a comparison of the third depth and the second depth to generate the updated rendering, the updated rendering not including the second object.

13. The method of claim 9, wherein the object is a first object and the method further comprises:
estimating a third depth between a second object at the scene and the camera, based on the scene data,
the rendering further updated based on a comparison of the third depth and the second depth to generate the updated rendering, the updated rendering (1) rendering the first object at a first focus and (2) rendering the second object at a second focus different than the first focus.

14. The method of claim 9, wherein the eye is a first eye, the user has a second eye, and estimating the gaze point includes:
determining a vector associated with the first eye;
determining a vector associated with the second eye; and
determining, using a machine learning model, the gaze point based on the vector associated with the first eye and the vector associated with the second eye.

15. The method of claim 14, further comprising:
updating the machine learning model based on the gaze point.

16. The method of claim 9, further comprising:
displaying the updated rendering via foveated rendering.

17. A non-transitory, processor-readable medium storing instructions that, when executed by a processor, cause the processor to:
receive scene data of a scene captured by a camera;
generate a rendering of the scene based on the scene data;
estimate, based on the scene data, a first depth between an object at the scene and the camera;
receive eye-tracking data (1) for an eye of a user and (2) captured by an eye-tracking sensor;
estimate, based on the eye-tracking data, a gaze point of the eye associated with the object at the scene;
estimate a second depth between the eye of the user and the gaze point of the user, based on the eye-tracking data and a focal depth of the eye of the user; and
update the rendering based on the first depth and the second depth to generate an updated rendering.

18. The non-transitory, processor-readable medium of claim 17, wherein the object is a first object and non-transitory, processor-readable medium further stores instructions that, when executed by the processor, cause the processor to:
estimate, based on the scene data, a third depth between a second object at the scene and the camera,
the rendering further updated based on a comparison of the third depth and the second depth to generate the updated rendering, the updated rendering not including the second object.

19. The non-transitory, processor-readable medium of claim 17, wherein the object is a first object and non-transitory, processor-readable medium further stores instructions that, when executed by the processor, cause the processor to:
estimate, based on the scene data, a third depth between a second object at the scene and the camera,
the rendering further updated based on a comparison of the third depth and the second depth to generate the updated rendering, the updated rendering (1) rendering the first object at a first focus and (2) rendering the second object at a second focus different than the first focus.

20. The non-transitory, processor-readable medium of claim 17, wherein the object is a first object and non-transitory, processor-readable medium further stores instructions that, when executed by the processor, cause the processor to:
determine a confidence value associated with the first depth; and
determine a confidence value associated with the second depth,
updating the rendering to generate the updated rendering further based on the confidence value associated with the first depth and the confidence value associated with the second depth.
